(19) United States
(12) Patent Application Publication
(10) Pub. No.: US 2024/0266811 A1
(43) Pub. Date: Aug. 8, 2024

(54) MOUNTING SYSTEM FOR POWER TRANSMISSION LINE TOWERS

(71) Applicant: LineVision, Inc., Boston, MA (US)

(72) Inventor: Evan Jacob, Framingham, MA (US)

(21) Appl. No.: 18/410,267

(22) Filed: Jan. 11, 2024

Related U.S. Application Data
(60) Provisional application No. 63/483,860, filed on Feb. 8, 2023.

(51) Int. Cl. H02G 1/04; H02G 7/05

(52) U.S. Cl. CPC H02G 1/04; H02G 7/053

(57) ABSTRACT

A transmission line tower mounting system including a corner piece for receiving a member of the transmission line tower, two end brackets, and two threaded rods, each extending from the corner piece to a respective one of the two brackets.

### RELATED APPLICATION

This application claims the benefit under 35 USC 119(e) of U.S. Provisional Application No. 63/483,860, filed on Feb. 8, 2023, which is incorporated herein by reference in its entirety.

### BACKGROUND OF THE INVENTION

A typical overhead power transmission line system includes three energized phase conductors, consisting of a single stranded cable or of two or more stranded sub-conductors arranged in a bundle, and one or more non-energized overhead ground wires (OHGW), separated from each other in a spatial configuration. These conductors run between transmission line (or support) towers from which they are hung via insulators. Conductors are typically composed of strands of steel, aluminum, copper, alloyed metals, or carbon composite materials, with various surface treatments applied to achieve desired corrosion resistance (e.g. zinc galvanization), optical, and other properties. Each conductor often carries a different phase of the power transmitted through the system, and the total power flowing through the transmission line is the summation of the power flowing through each of the three phases. Conductor bundles typically consist of two to four conductors connected by spacers. The conductors making up each transmission line may carry alternating current (AC) and voltage at a specific frequency (60 Hz in the United States, 50 Hz in Europe), direct current (DC) and voltage, or may be de-energized during construction, maintenance, or emergency outage periods.

Transmission line towers are typically constructed using steel extrusion, cables, and other components. The steel extrusions are generally made from steel tubes or angle iron and are bolted together to form the tower. In addition to these lattice towers, there are also monopoles. All of these towers have to be able to withstand the weight and wind load of the lines, insulators, and other components that they support.

### SUMMARY OF THE INVENTION

It is often necessary to mount devices on the transmission line towers. Commonly, monitoring systems are mounted on the towers to monitor the conductors.

The present invention concerns a mounting system for mounting to transmission line towers and in particular the lengths of metal tube or angle iron that typically form the corners or other spans of the transmission line towers.

Towers are typically constructed from angle iron ranging from 3 to 8 inches on a side. The present mounting system can adapt any; size angle iron/right angle/L-beam to pipe or strut.

In general, according to one aspect, the invention features a mounting system for mounting to a transmission line tower. The system comprises a corner piece for receiving a member of the transmission line tower, two end brackets, and two threaded rods, each extending from the corner piece to a respective one of the two brackets.

The corner piece preferably includes two integrated L brackets that receive the threaded rods. The corner piece can also include a union segment extending from the two integrated L brackets to a mounting segment. This union segment can receive a pole mounting loop, range of mounting u-bolts, unistrut, and/or other hardware.

The two end brackets can be “L” shaped.

In general, according to another aspect, the invention features a mounting system for mounting to a transmission line tower. The system comprises a corner piece for receiving a member of the transmission line tower and two obtuse brackets mounted to the corner piece, the two obtuse brackets each having a slot having the option to receive one or more bands for mounting to the member.

In general, according to another aspect, the invention features a mounting method for mounting to a transmission line tower. The method comprises locating a corner piece on a member of the transmission line tower, placing two end brackets on the member, and clamping the two end brackets to the member with two threaded rods, each extending from the corner piece to a respective one of the two brackets.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is perspective view of the mounting system according to the present invention;

FIG. 2 is a perspective view of the mounting system clamped onto a transmission tower angle iron;

FIG. 3 is a perspective view of the mounting system clamped onto a transmission tower angle iron in a different orientation;

FIG. 4 is a perspective view of the mounting system with the angle iron hidden;

FIGS. 5 and 6 is a scale perspective view of the mounting system configured for receiving metal mounting band(s), with FIG. 6 showing the band.

### DETAILED DESCRIPTION OF THE PREFERRED EMBODIMENTS

The invention now will be described more fully hereinafter with reference to the accompanying drawings, in which illustrative embodiments of the invention are shown. This invention may however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

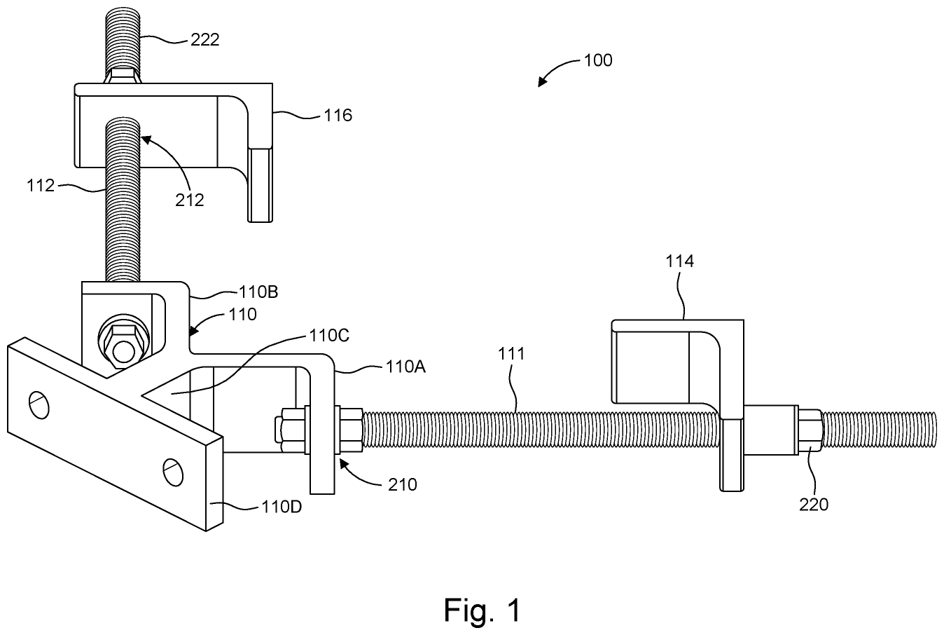

FIG. 1 is scale perspective view of the mounting system 100.

In general, the mounting system comprises a corner piece 110 and a first L end bracket 114 and a second L end bracket 116.

A first threaded rod 111 extends between the corner piece 110 and the first L end bracket 114 on one side. A second threaded rod 112 extends between the corner piece 110 and a second L end bracket 116 on a second side.

In particular, the corner piece 110 includes a right integrated L bracket 110A. It includes a hole 210 on its distal leg for receiving the first threaded rod 111, which is clamped to the distal leg by two nuts on the threaded rod 111. In the illustrated example, the threaded rod 111 is held in the hole 210 on the right integrated L bracket 110A with two nuts or other fixtures or by welding or even possibly the rod is integral with the bracket.

In a similar vein, the second threaded rod 112 is held in a hole 212 on the left integrated L bracket 110B with two more nuts.

The right integrated L bracket 110A and the left integrated L bracket 110B joined together at a union segment 110C. The unions segment 110C ends in a laterally extending mounting segment 110D.

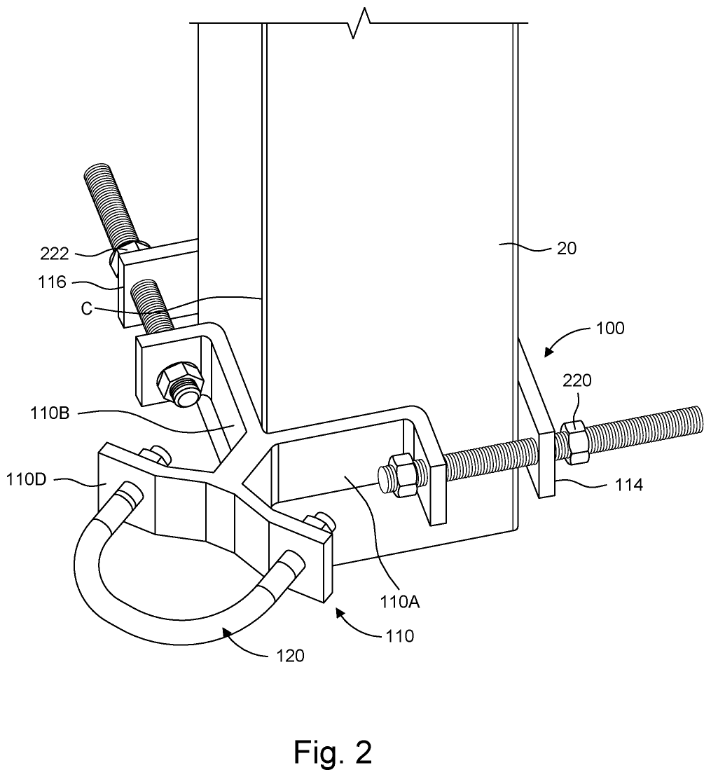

FIG. 2 is a scale perspective view of the mounting system 100 clamped onto a member of a tower and specifically a transmission tower angle iron 20. In this configuration, the crown C of the transmission tower angle iron 20 sits between the left integrated L bracket 110B and the right integrated L bracket 110A. A pole mounting loop lp20 is connected to the mounting segment 100D to receive a pole P (not shown in this figure) for mounting on the transmission tower angle iron 20. In this orientation, the clamped pole runs along the crown of the angle iron. Tightening bolts 220, 222 drive the respective L brackets 114, 116 into engagement with the transmission tower angle iron 20 to clamp the system to the angle iron.

It is also evident that the present mounting system can accommodate different sized angle iron 20 by simply choosing the length of the first threaded rod 111 and the second threaded rod 112.

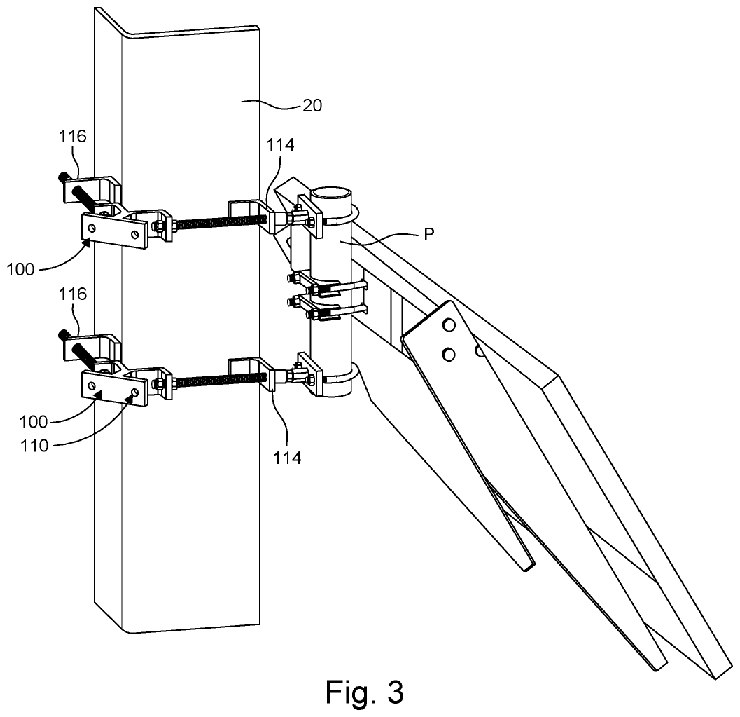

FIG. 3 is a scale perspective view of the mounting system clamped onto a transmission tower angle iron and holding a pole for carrying a solar panel for providing power to a transmission line monitoring system. In this orientation, the clamped pole runs along the leg of the angle iron 20.

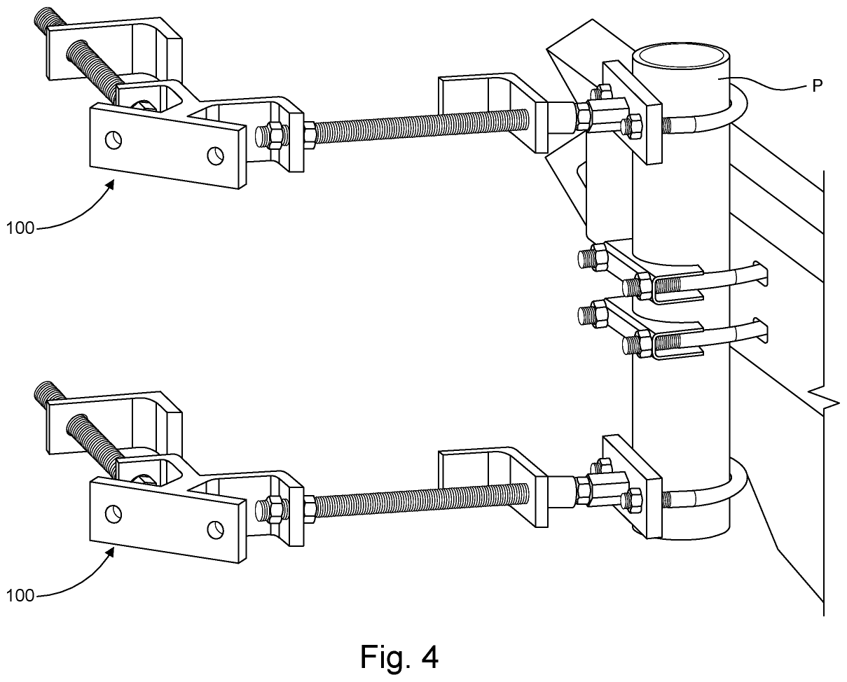

FIG. 4 is a scale perspective view of the mounting system with the transmission tower angle iron hidden.

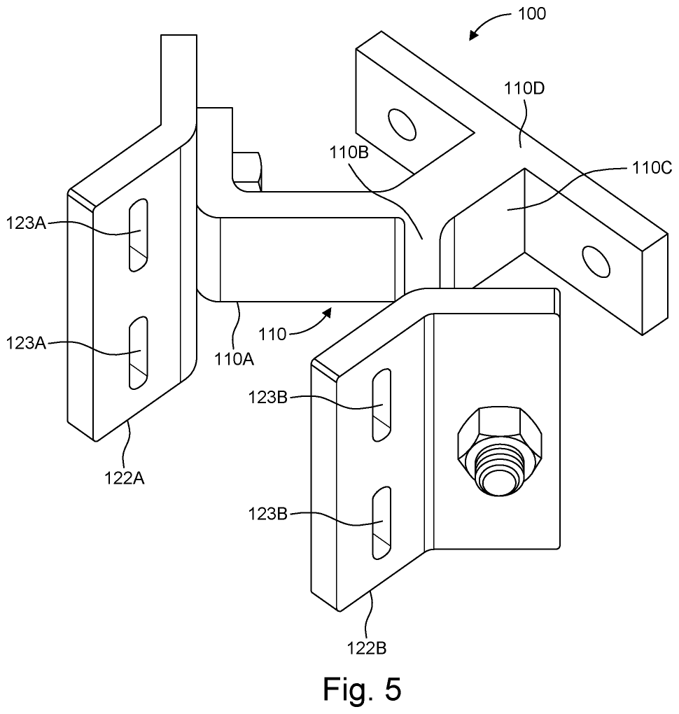

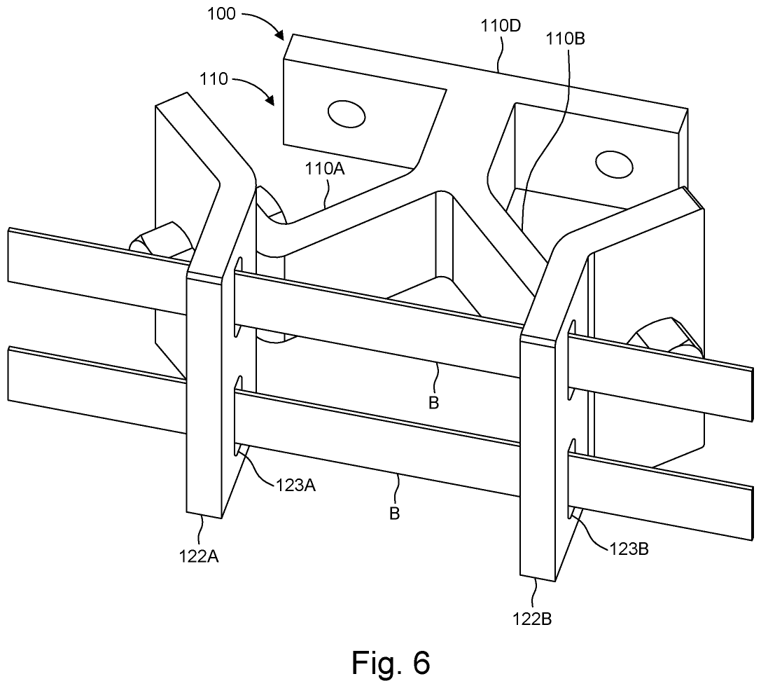

FIGS. 5 and 6 is a scale perspective view of the mounting system 100 configured for receiving one or more metal mounting bands B, with FIG. 6 showing the bands B. Specifically, the band B is received through slots 123A, 123B formed in two obtuse brackets 122A, 122B connected respectively to the right integrated L bracket 110A and left integrated L bracket 110B of the corner piece.

This design is especially useful for monopole-type towers allowing mounting to members of these towers. These bands allow the mounting system to be attached directly around waists of the monopoles.

While this invention has been particularly shown and described with references to preferred embodiments thereof, it will be understood by those skilled in the art that various changes in form and details may be made therein without departing from the scope of the invention encompassed by the appended claims.

What is claimed is:

1. A mounting system for mounting to a transmission line tower, comprising:
a corner piece for receiving a member of the transmission line tower;
two end brackets; and
two threaded rods, each extending from the corner piece to a respective one of the two brackets.

2. The mounting system of claim 1, wherein the corner piece includes two integrated L brackets that receive the threaded rods.

3. The mounting system of claim 1, wherein the corner piece includes a union segment extending from the two integrated L brackets to a mounting segment.

4. The mounting system of claim 3, wherein the union segment receives a pole mounting loop.

5. The mounting system of claim 1, wherein the two end brackets are “L” shaped.

6. A mounting system for mounting to a transmission line tower, comprising:
a corner piece for receiving a member of the transmission line tower;
two obtuse brackets mounted to the corner piece, the two obtuse brackets each having a slot to receive a band for mounting to the member.

7. A mounting method for mounting to a transmission line tower, comprising:
locating a corner piece on a member of the transmission line tower;
placing two end brackets on the member; and
clamping the two end brackets to the member with two threaded rods, each extending from the corner piece to a respective one of the two brackets.
